(19) United States
(12) Patent Application Publication
(10) Pub. No.: US 2024/0169509 A1
(43) Pub. Date: May 23, 2024

(54) CLOSED-LOOP AUTOTUNING FRAMEWORK FOR IMAGE SIGNAL PROCESSOR TUNING

(71) Applicant: Apollo Autonomous Driving USA LLC, Sunnyvale, CA (US)

(72) Inventors: Szu-Hao WU, Sunnyvale, CA (US); Shu JIANG, Sunnyvale, CA (US); Jeong Ho LYU, Sunnyvale, CA (US); Linpeng CHENG, Sunnyvale, CA (US); Hao LIU, Sunnyvale, CA (US); Helen K. PAN, Sunnyvale, CA (US)

(21) Appl. No.: 18/058,593

(22) Filed: Nov. 23, 2022

(51) Int. Cl. G06T 7/00

(52) U.S. Cl. CPC G06T 7/0002; G06T 2207/10024; G06T 2207/30168; G06T 2207/30252

(57) ABSTRACT

The disclosure describes an autotuning framework for tuning an image signal processing (ISP) module of an autonomous driving vehicle (ADV). The autotuning framework can generate different sets of parameter values using a variety of optimization algorithms to configure the ISP module. Each processed image generated by the ISP module configured with the different sets of parameter values is compared by an ISP module testing device with a reference image stored therein to generate an objective core measuring one or more differences between each of the processed images and the reference image. The objective scores and the corresponding sets of parameter values are stored in a database. Different sets of optimal parameter values for different environments can be selected from the database, and uploaded to a cloud database for use by an ADV, which can select a different set of ISP parameter values based on an environment that the ADV is travelling in.

### TECHNICAL FIELD

Embodiments of the present disclosure relate generally to autonomous driving vehicles. More particularly, embodiments of the disclosure relate to image signal processing (ISP) module tuning autonomous driving vehicles.

### BACKGROUND

An autonomous driving vehicle (ADV), when driving in an automatic mode, can relieve occupants, especially the driver, from some driving-related responsibilities. When operating in an autonomous mode, the vehicle can navigate to various locations using onboard sensors, allowing the vehicle to travel with minimal human interaction or without any passengers.

An autonomous driving vehicle (ADV) may include multiple image sensors (e.g., cameras) to capture the surrounding environment of the ADV. The surrounding environment may include the physical environment around the ADV, such as roads, other vehicles, buildings, people, objects, etc. Each image sensor may produce one or more images that, when taken consecutively, may form an image stream. The number of image sensors may vary from one vehicle to another. Various image sensors may be placed at different positions on the ADV to capture the environment from their respective perspective, such as from a given location at a given angle relative to the ADV.

Prior to using a captured image by the ADV, the ADV needs to use an ISP module to convert the raw image into digital form through a series of operations such as noise reduction to enhance the quality of the image. An ISP module may have dozes of parameters, the values of which need to be optimized to produce images of optimal quality.

Traditionally, the tuning of an ISP module is performed manually, which requires a user to adjust one of many parameters at a time. This manual approach is not only labor-intensive, but also makes it hard to find a set of balanced parameter values.

### BRIEF DESCRIPTION OF THE DRAWINGS

Embodiments of the disclosure are illustrated by way of example and not limitation in the figures of the accompanying drawings in which like references indicate similar elements.

FIG. 1 is a schematic diagram illustrating a closed-loop autotuning framework for tuning an ISP module of an ADV according to an embodiment of the invention.

FIG. 2 shows an example of the ISP module 107 according to an embodiment of the invention.

FIG. 3 illustrates an example of an ISP module testing device according to an embodiment of the invention.

FIG. 4 illustrates an example of the cloud database 110 in the cloud server 108 according to an embodiment of the invention.

FIG. 5 is a block diagram further illustrating a process flow of the automatic parameter autotuning framework 101 according to one embodiment.

FIG. 6 illustrates an ADV 601 that uses parameter values in the cloud database 110 in automatic driving according to an embodiment of the invention.

FIG. 7 is a flow chart illustrating a process 700 of turning an ISP module according to an embodiment of the invention.

FIG. 8 is a flow chart illustrating a process 800 of operating an autonomous driving vehicle according to an embodiment of the invention.

FIG. 9 is a block diagram illustrating an autonomous driving vehicle according to an embodiment of the invention.

FIG. 10 is a block diagram illustrating a control system of the autonomous driving vehicle according to an embodiment of the invention.

FIG. 11 is a block diagram illustrating an example of the autonomous driving system according to an embodiment of the invention.

### DETAILED DESCRIPTION

Various embodiments and aspects of the disclosures will be described with reference to details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosures.

Reference in the specification to “one embodiment” or “an embodiment” means that a particular feature, structure, or characteristic described in conjunction with the embodiment can be included in at least one embodiment of the disclosure. The appearances of the phrase “in one embodiment” in various places in the specification do not necessarily all refer to the same embodiment.

The disclosure describes an autotuning framework for tuning an image signal processing (ISP) module of an autonomous driving vehicle (ADV). The autotuning framework can generate different sets of parameter values using a variety of optimization algorithms to configure the ISP module. Each processed image generated by the ISP module configured with the different sets of parameter values is compared by an ISP module testing device with a reference image stored therein to generate an objective core measuring one or more differences between each of the processed images and the reference image. The objective scores and the corresponding sets of parameter values are stored in a database. Different sets of optimal parameter values for different environments can be selected from the database, and uploaded to a cloud database for use by an ADV, which can select a different set of ISP parameter values based on an environment that the ADV is travelling in.

In an embodiment, the set of optimal parameter values corresponds to a highest objective score in the database. Examples of the set of ISP parameter values include a white balance gain, a static color saturation, and a noise reduction strength. Examples of the optimization algorithms include a random search algorithm, a grid search algorithm, and a Bayesian algorithm.

In an embodiment, the set of predetermined number of iterations can be specified in a configuration file either via a fixed number or via a target objective score.

In another embodiment, a method of operating an autonomous driving vehicle (ADV) is disclosed. The ADV can receive a raw image captured by the sensor system on the ADV in a particular environment, determines a color temperature value of the raw image, and obtains a set of ISP parameter values corresponding to the color temperature value from a cloud database. The ADV can configures the ISP module using the set of ISP parameter values, and operates the ADV using processed images from the ISP module.

The above summary does not include an exhaustive list of all aspects of the present invention. It is contemplated that the invention includes all devices, computer media, and methods that can be practiced from all suitable combinations of the various embodiments summarized above, and also those disclosed in the Detailed Description below.

### Autotuning Framework

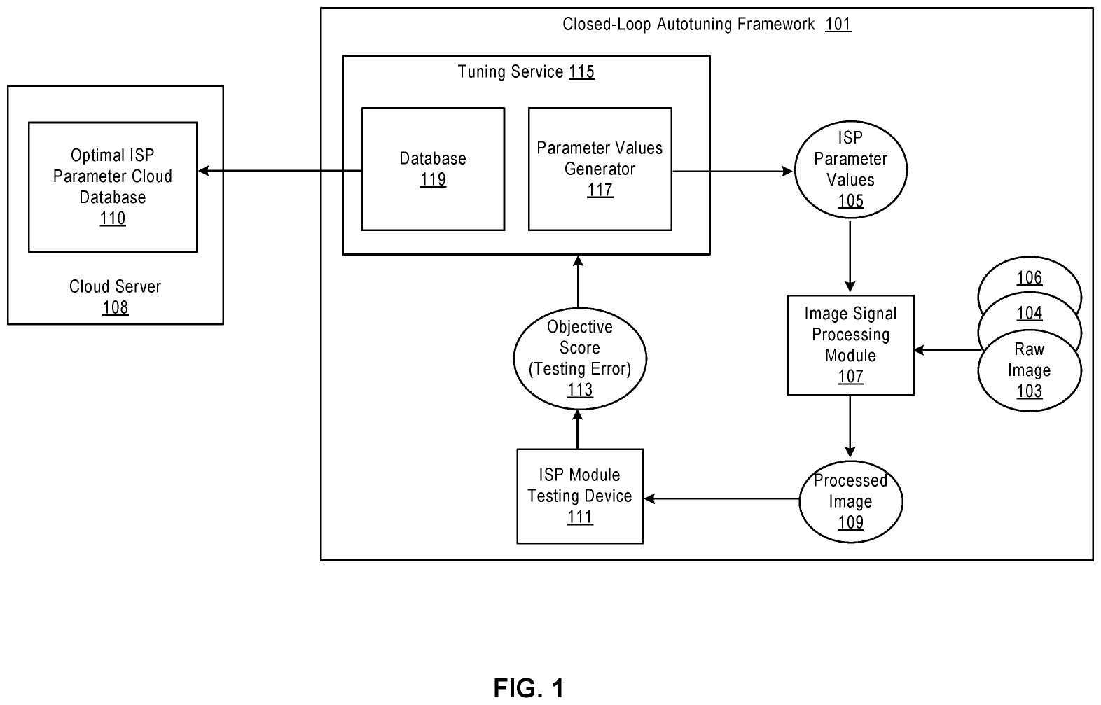

FIG. 1 is a schematic diagram illustrating a closed-loop autotuning framework for tuning an ISP module of an ADV according to an embodiment of the invention.

The framework can address the disadvantages of a traditional manual tuning approach that is labor-intensive and requires a user to manually adjust ISP parameter values one at a time. Compared with the traditional, the closed-loop autotuning framework 101 can adjust values of the parameters of the ISP module 107 all at once, thus making it not only efficient but also easier to find a set of optimal and balanced parameter values.

As shown in FIG. 1, the autotuning framework 101 can include a tuning service 115, an ISP module 107, and an ISP module testing device 111. The tuning service 115 can further include a parameter values generator 117 and a database 119. The parameter values generator 117 can generate ISP parameter values using a sampling method according to one of many optimization algorithms. An optimization algorithm may include a procedure which is executed iteratively by comparing various solutions (e.g., previous ISP parameter values and their corresponding scores stored in the database) until an optimum or a satisfactory solution is found. The optimization algorithm can utilize historical data and trends to determine which direction the ISP parameter values should be generated for each iteration. Examples of optimization algorithms include a differentiable objective function (e.g., using a first-order derivative, gradient, partial derivative, second-order derivative, etc.), a bracketing algorithm (e.g., a Fibonacci search, golden section search, bisection method, etc.), a local descent algorithm (e.g., a line search), first-order algorithms (e.g., gradient descent, momentum, AdagGrad, Adam, etc.), second order algorithms, direct algorithms, non-differential objective functions, or other optimization algorithms. The parameter values generator 117 may also use one of may search algorithms to search ISP parameter(s) for a next iteration of the closed-loop. Examples of search algorithms may include a random search algorithm, a grid search algorithm, or a Bayesian algorithm.

In an embodiment, a configuration file can be used to specify the type of sampling method used to generate ISP parameters as well a number of iterations in the tuning process for tuning the ISP module 107.

The ISP module 107 can be an application that can perform a series of operations to transform a raw image captured by a sensor into a high-quality image. Examples of the operations can include noise reduction, auto-white balance & color correction, color interpolation, lens shading correction, defect pixel correction, gamma correction, local tone mapping, auto exposure, and auto focus. Each of the above operations may have a corresponding parameter whose values can be adjusted. The ISP module 107 can be installed in the ADV or in a computing environment (e.g., a server) that is separate from the ADV.

The ISP module testing device 111 can be a testing tool, which includes a reference image that is derived from a raw image 103 and that serves as a benchmark for processed images from the ISP module 107 to match. The closed-loop autotuning process illustrated in FIG. 1 can be viewed as a process for processed images from the ISP module 107 to approach the quality of the reference image.

In each of the number of iterations specified in the configuration file mentioned above, the parameter values generator 117 can generate a set of values 105 for the set of ISP parameters of the ISP module 107, and can substitute existing values of the parameters with the newly generate values 105. Configured with the new parameter values, the ISP module 107 can generate a processed image 109 from the raw image 103. The autotuning framework 101 can send the processed image 109 to the ISP module testing device 111, which can generate an objective score 113 indicating one or more differences between the reference image in the ISP module testing device 111 and the processed image 109 in terms of image quality.

In an embodiment, the ISP parameter values 105 can be the values for all the parameters in one of the modules (e.g., a noise reduction module), or values for all the parameters for all modules in the ISP module 107.

In an embodiment, the ISP module testing device 111 can compare the processed image 109 with the reference image in terms of the following example attributes, e.g., hue, saturation, and brightness and other attributes measuring the performance of the ISP module 107. The ISP module testing device 111 may assign a value (with 100 being the highest value) to each attribute of the processed image 109 based on an analysis of the processed image 109, and assign a value of 100 to the same attribute of the reference image. The ISP module testing device 111 can compute differences between the values of the attributes of the processed image 109 and the corresponding values of the reference image, and calculate a weighted average of the differences between the processed images and the reference image. An inverse of the weighted average is used as the objective score 113. Thus, the higher the objective score, the smaller the differences are between the reference image and the processed image 109. The tuning framework 101 can store the objective score 113 to the database 119 together with the set of ISP parameter values 105.

Thus, after the number of iterations specified in the configuration file, the database 119 can include a table with entries matching parameter values and objective scores for all the iterations in the autotuning process. The number of iterations in the autotuning process can be determined as a fixed number (e.g., 1000 times) or depends on a specified target objective score. For example, the configuration file can specify a target objective score (e.g., 90), which would require the autotuning framework 101 to loop as many iterations as needed for the objective score 113 to reach the target objective score.

When the closed-loop is over, the tuning service 115 can determine whether the configuration file specifies a fixed number of iterations or a target objective score. If a target objective score is found, the set of parameter values corresponding to the target objective score would be the best/optimal parameter values, which can be uploaded to a cloud database 110 in a cloud server 108.

If a fixed number of iterations is specified in the configuration file, then the set of parameter values corresponding to the highest objective score would be the best ISP parameter values that can be uploaded to a cloud database 110 in a cloud server 108.

In an embodiment, raw images taken in different environments can be used for tuning the ISP module 107 to generate optimal ISP parameters for the different environments.

For example, the raw image 103 can be taken in an ambient brightness, another raw image 104 can be taken in the darkness, and yet another raw image 106 can be taken in a sunny day. One or more attributes (e.g., the color temperature) of the raw images 103, 104, and 106 can be different due to the different environments under which the raw images were taken. For each of the raw images 103, a set of optimal ISP parameter values for the ISP module 107 can be found and uploaded to the cloud database 110.

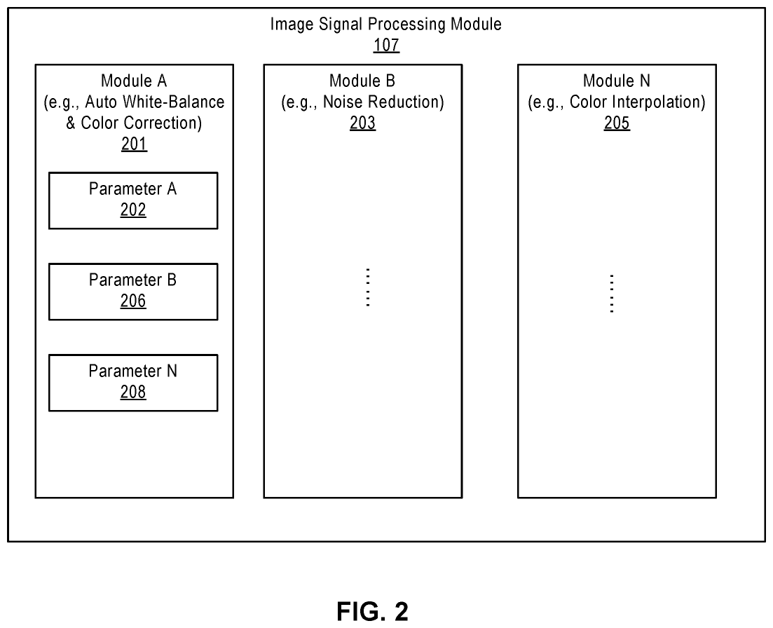

FIG. 2 shows an example of the ISP module 107 according to an embodiment of the invention.

As shown, the ISP module 107 can include multiple modules 201, 203, and 205. Examples of the modules can include a noise reduction module, an auto white-balance & color correction module, a color interpolation module, a lens shading correction module, a defect pixel correction module, a gamma correction module, a local tone mapping module, an auto exposure module, and an auto focus module.

The modules in the ISP modules perform operations to transform a raw image captured by a sensor (e.g., a camera) to a high-quality image. For example, the noise reduction module can erase noise in the raw image and provides clear images. The auto white-balance & color correction module can ensure proper color fidelity in the captured raw image by adjusting the colors to fit a particular output color space. The color interpolation module can convert the raw image captured using a Bayer color filter array (CFA) into a color RGB image.

Each module can include a number of parameters whose values can be adjusted. For example, module A 201 can include parameters 202, 206, and 208. The parameters for each of the other modules are not shown in the figure, and not all the modules in the ISP modules 107 are shown in the figure. The parameters for each of the modules 201, 203, and 205 can be adjusted one at a time manually, but in order for two or more of the parameters in each module to be tuned, the closed-loop autotuning framework 101 is needed.

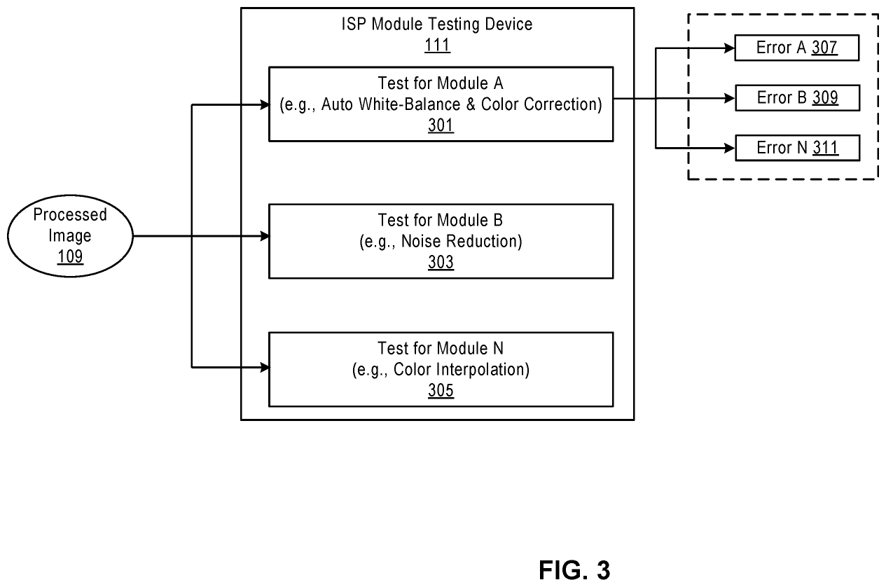

FIG. 3 illustrates an example of the ISP module testing device 111 according to an embodiment of the invention.

The ISP module testing device 111 can be Imatest™, and can include a hardware component, such as one or more test charts produced on a variety of substrates. These test charts can be considered reference images. Further, the ISP module testing device 111 can include one or more software components for evaluating the quality of the processed images from the ISP module 107. The software components can analyze the resolution, color temperature, chromatic aberration, and geometric distortion of each processed image and generate results indicating testing errors.

As shown in the figure, the processed image 109 from a raw image taken in a particular environment is used an example. The processed image 109 can be fed into the ISP module testing device 111, which can test the performance of each module in the ISP module 107 using a corresponding testing module 301, 303, and 305. Each of the testing modules 301, 303, and 305 can generate an error for each of the parameters of the corresponding module in the ISP module 107.

For example, the testing module 301 is for testing the performance of the auto white-balance & color correction module of the ISP module 107, and can generate errors 307, 309, and 311. These errors indicate the performance of the white-balance & color correction module in processing the raw image 103 in comparison to the testing chart (i.e., the reference image). The testing errors of the other testing modules are not shown in this figure, but a skilled artisan would understand what these errors are.

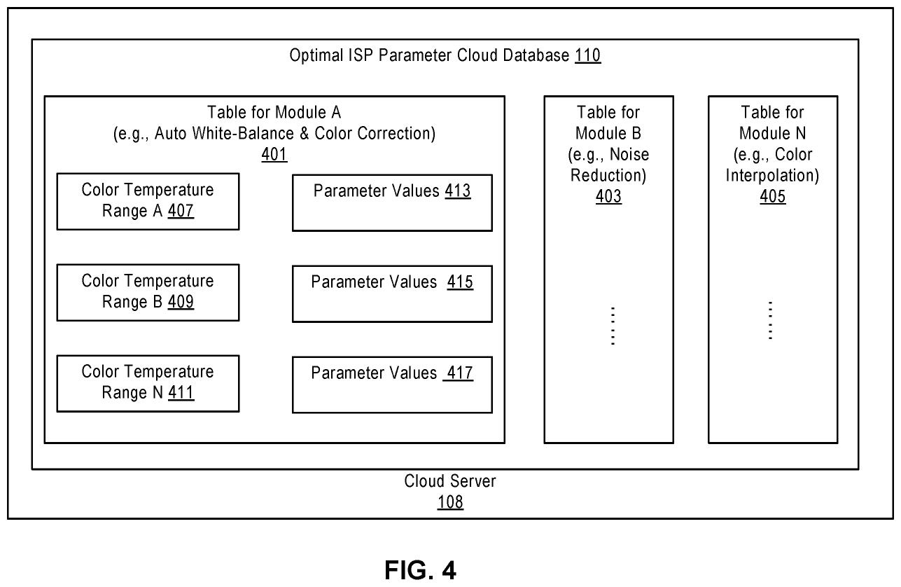

FIG. 4 illustrates an example of the cloud database 110 in the cloud server 108 according to an embodiment of the invention.

As shown, the cloud database 110 can include at least one table for each module in the ISP module 107. For example, a table 401 can be created for module A, another table 403 can be created for module B, and yet another table 405 can be created for module N.

Each of these tables 401, 403, and 405 can include mapping entries between sets of parameter values and color temperature ranges. For example, in the table 401, color temperature ranges 407, 409, and 411 have a one-to-one relationship with different sets of values for the parameters of module A. The contents of the other tables 403 and 405 are not shown, but a skilled artisan would appreciate that color temperature ranges in each of the other tables 403 and 405 would be the same as the color temperature ranges 407, 409, and 4011 except that each range in each of the other tables 403 and 405 may correspond to a different set of values.

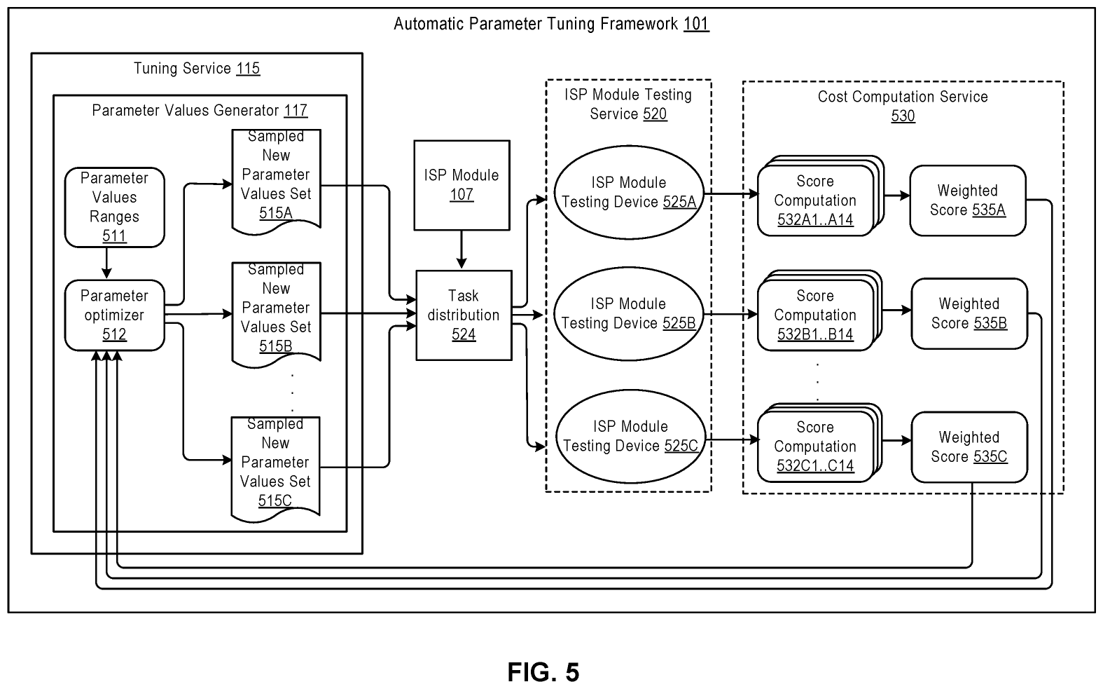

FIG. 5 is a block diagram further illustrating a process flow of the automatic parameter autotuning framework 101 according to one embodiment.

The automatic parameter autotuning framework 101 includes the tuning service 115, an ISP module testing service 520, a task distribution logic 524, and a cost computation service 530. To achieve high efficiency, the parameter values generator supports a parallel evaluation process by spawning multiple worker threads to sample different sets of parameter values at the same time. The sampling method can be customized based upon a parameter optimizer 512 and a sampling policy. The parameter optimizer 512 can be a Bayesian Global Optimizer, which can utilize multiple probability models for approximating the objective functions, e.g., Gaussian Process Regress (GPR) and Tree-structured Parzen Estimator (TPE).

Parameter values ranges 511 can be predefined for the parameters for the ISP module 107. For example, if the range of values for a parameter, e.g., noise reduction strength, is within a particular range, the parameter values generator 117 would not select values for the parameter that is not in the particular range when generating the multiple sets of parameter values 515.

Each set of the sets of parameter values 515 can be applied to the ISP module 107 107 to configure the ISP module 107, which can generate a processed image to be tested in the ISP module testing service 520.

Testing each processed image can be considered a task. The task distribution logic 524 can manage the tasks, and send requests to the ISP module testing service 520 to execute the tasks. The ISP module testing service 520 can run multiple instances 525A, 525B, and 525C of the ISP module testing device 111. Since the tasks are independent of each other, another round of efficiency boost is accomplished in the ISP module testing service 520 by running all tasks in parallel and returning the execution records to the cost computation service 530 separately.

Upon receipt of the requests, each execution record, the cost computation service 530 calculates a score 532 for each attribute of the processed image that corresponds to one of the parameter value in the parameter value set. An inverse of a weighted average score 535 is each processed image. The inverse of the weighted average score 535 is fed back to the tuning service 115 for optimization in a next iteration by parameter values generator 117.

In an embodiment, for each tunable parameter, the parameter values generator 117 selects an initial (“first”) value. The initial value for each tunable parameter can be randomly selected within a value range space for the tunable parameter.

The parameter optimizer 512 iterates the data flow for a predetermined fixed number of times. Each iteration produces a single weighted score 535, whose inverse is used as an objective score by the parameter optimizer 512 to modify the sampled parameter values sets 515 for a next iteration of the parameter optimizer 512. When the fixed number of iterations have been performed, the parameter optimizer 512 determines the optimal value for each tunable parameter. In subsequent iterations, parameter optimizer 512 can modify the values of the plurality of tunable parameters at each iteration of the optimization operations described herein. In an embodiment, parameter optimizer 512 can use the inverse of the weighted score 535 to modify the values of the plurality of tunable parameters for a next iteration of the parameter optimizer 512.

Parameter optimizer 512 can be configured to generate a predetermined fixed number of sets of tunable parameters 515 (also termed “sampled new parameter values sets 515”), such as sets of sampled new parameter values 515A . . . 515C. The sampled new parameter values 515A . . . 515C can be tested simultaneously, in parallel, and independently from one another.

In an embodiment, the weights used to generate the weighted score 535 reflect higher, or lower, relative importance of certain metrics in the plurality of metrics used to generate a score 532 for that metric. In this embodiment, examples of the metrics can include white balance gain, a static color saturation, and a noise reduction strength.

The cost computation service 530 provides inverses of weighted scores 535A . . . 535C to the parameter optimizer 512, which can use the inverses of the weighted score 535 to generate sampled new parameter values 515 for a next iteration (“repetition”) of the optimizer.

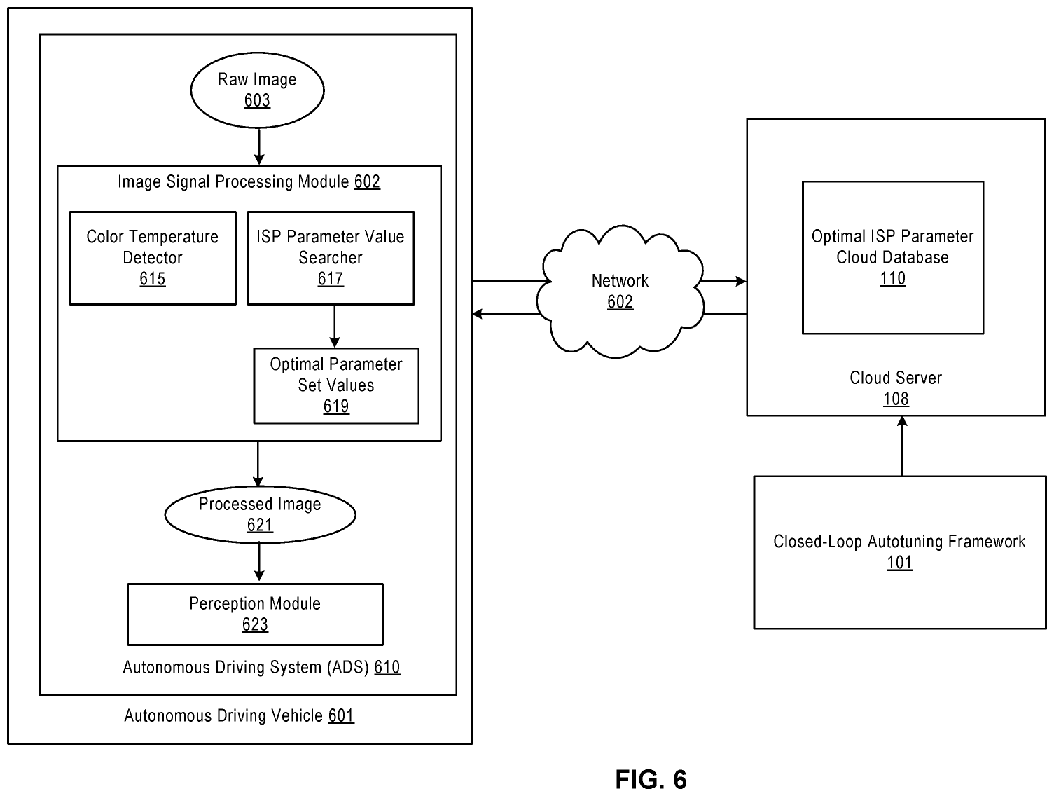

FIG. 6 illustrates an ADV 601 that uses parameter values in the cloud database 110 in automatic driving according to an embodiment of the invention.

As shown in the figure, the ADV 601 can include an ISP module 602 in an autonomous driving system (ADS) 610. The ISP module 602 can be the same as the ISP module 107 except the ISP module 602 is installed in the ADV 601. The ISP module 602 can include a color temperature detector 615, and an ISP parameter value searcher 617. The color temperature detector 615 can generate a value indicating a color temperature of a raw image 603 captured by a camera of the ADV 601 in a particular environment (e.g., sunny day). The value can be passed to the ISP parameter value searcher 617, which periodically (e.g., each 10 seconds) searches for a set of corresponding optimal ISP parameter values 619 in the cloud database 110 based on the color temperature value.

In an embodiment, the ISP parameter value searcher 617 can have a default color temperature value in the ISP parameter value searcher 617 initially, and correspondingly, the set of optimal parameter set values can be preconfigured in accordance with the default color temperature value. As the ADV 601 is exposed to a new environment (e.g., in the darkness with beam lights on), and raw images are taken in the new environment, the ISP parameter value searcher 617 can take new color temperature values, use them to search for sets of new ISP parameter values corresponding to the new color temperature values, and use the sets of new ISP parameter values to configure the ISP module 602. Processed images (e.g., image 621) generated by the ISP module 602 can then be sent to a perception module 623 for use in operating the ADV 601.

In an embodiment, the optimal parameter set values 619 can be values for the parameters in one module or more modules of the ISP module 602. For each color temperature value, the ISP parameter value searcher 617 can determine which range the color temperature value belongs to, and then locate, in the cloud database 110, a set of parameter values corresponding to that range in each of the modules of the ISP module 602.

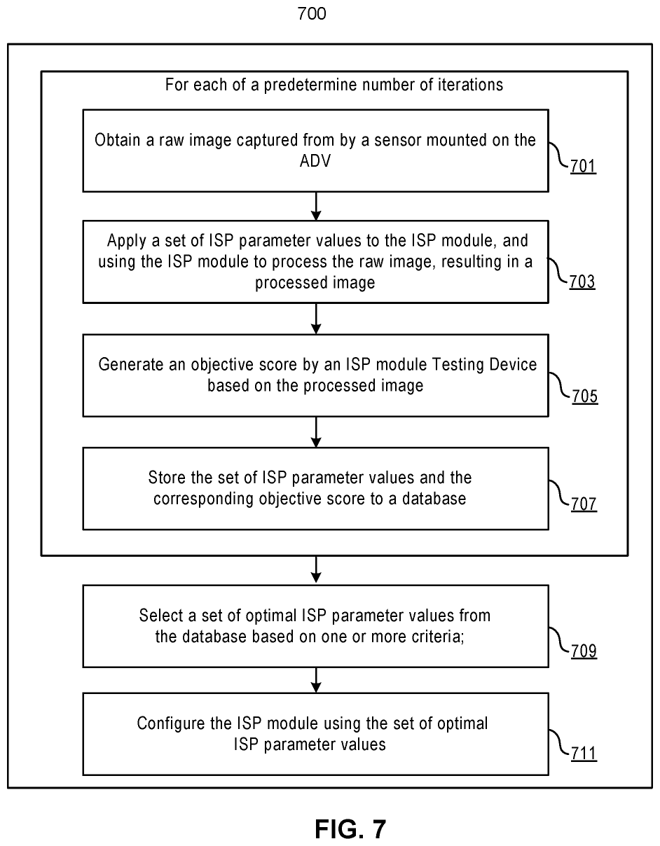

FIG. 7 is a flow chart illustrating a process 700 of turning an ISP module according to an embodiment of the invention. The process 700 may be performed by processing logic which may include software, hardware, or a combination thereof. For example, the process may be performed by various components and services in the autotuning framework 101 described in FIG. 1.

Referring to FIG. 7, the processing logic performs the following operations for a predetermined number of iterations.

In operation 701, the processing logic obtains a raw image captured from by a sensor mounted on the ADV. The image can be downloaded from an ADV via a network. In operation 703, the processing logic applies a set of ISP parameter values to the ISP module, and use the ISP module to process the raw image, resulting in a processed image. In operation 705, the processing logic generates an objective score by an ISP module testing device based on the processed image. In operation 707, the processing logic stores the set of ISP parameter values and the corresponding objective score to a database. In operation 709, the processing logic selects a set of optimal ISP parameter values from the database based on one or more criteria. In operation 711, the processing logic configures the ISP module using the set of optimal ISP parameter values.

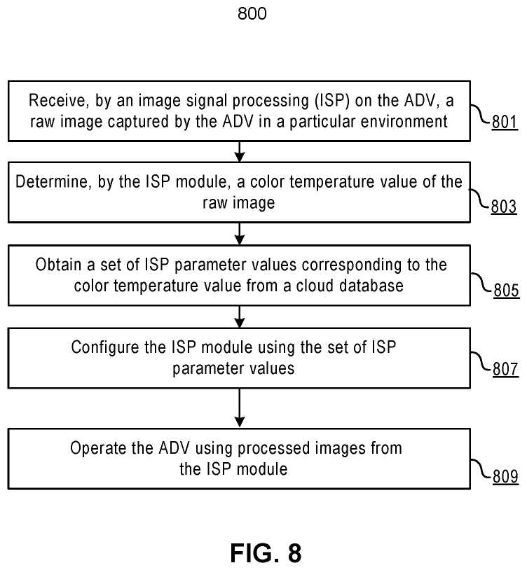

FIG. 8 is a flow chart illustrating a process 800 of operating an autonomous driving vehicle according to an embodiment of the invention. The process 700 may be performed by processing logic which may include software, hardware, or a combination thereof. For example, the process may be performed by various components and services in FIG. 6.

Referring to FIG. 8, in operation 701, the processing logic receives a raw image captured by the ADV in a particular environment. In operation 803, the processing logic determines a color temperature value of the raw image. In operation 805, the processing logic obtains that set of ISP parameter values corresponding to the color temperature value from a cloud database. In operation 807, the processing logic configures the ISP module using the set of ISP parameter values. In operation 809, the processing logic operates the ADV using processed images from the ISP module.

### Automatic Driving Vehicle

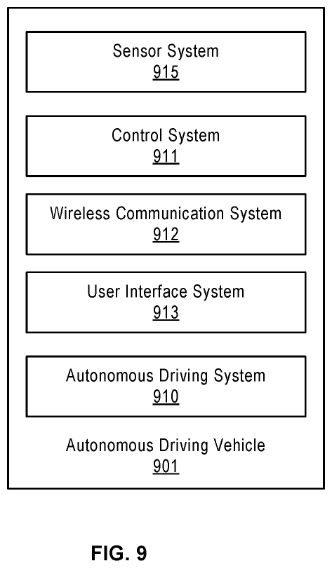

FIG. 9 is a block diagram illustrating an autonomous driving vehicle according to an embodiment of the invention. Referring to FIG. 9, autonomous driving vehicle 901 (the same ADV as ADV 601 in FIG. 6) may be communicatively coupled to one or more servers over a network, which may be any type of networks such as a local area network (LAN), a wide area network (WAN) such as the Internet, a cellular network, a satellite network, or a combination thereof, wired or wireless. The server(s) may be any kind of servers or a cluster of servers, such as Web or cloud servers, application servers, backend servers, or a combination thereof. A server may be a data analytics server, a content server, a traffic information server, a map and point of interest (MPOI) server, or a location server, etc.

An autonomous driving vehicle refers to a vehicle that can be configured to drive in an autonomous mode in which the vehicle navigates through an environment with little or no input from a driver. Such an autonomous driving vehicle can include a sensor system having one or more sensors that are configured to detect information about the environment in which the vehicle operates. The vehicle and its associated controller(s) use the detected information to navigate through the environment. Autonomous driving vehicle 901 can operate in a manual mode, a full autonomous mode, or a partial autonomous mode.

In one embodiment, autonomous driving vehicle 901 includes, but is not limited to, autonomous driving system (ADS) 910, vehicle control system 911, wireless communication system 912, user interface system 913, and sensor system 915. Autonomous driving vehicle 901 may further include certain common components included in ordinary vehicles, such as, an engine, wheels, steering wheel, transmission, etc., which may be controlled by vehicle control system 911 and/or ADS 910 using a variety of communication signals and/or commands, such as, for example, acceleration signals or commands, deceleration signals or commands, steering signals or commands, braking signals or commands, etc.

Components 910-915 may be communicatively coupled to each other via an interconnect, a bus, a network, or a combination thereof. For example, components 910-915 may be communicatively coupled to each other via a controller area network (CAN) bus. A CAN bus is a vehicle bus standard designed to allow microcontrollers and devices to communicate with each other in applications without a host computer. It is a message-based protocol, designed originally for multiplex electrical wiring within automobiles, but is also used in many other contexts.

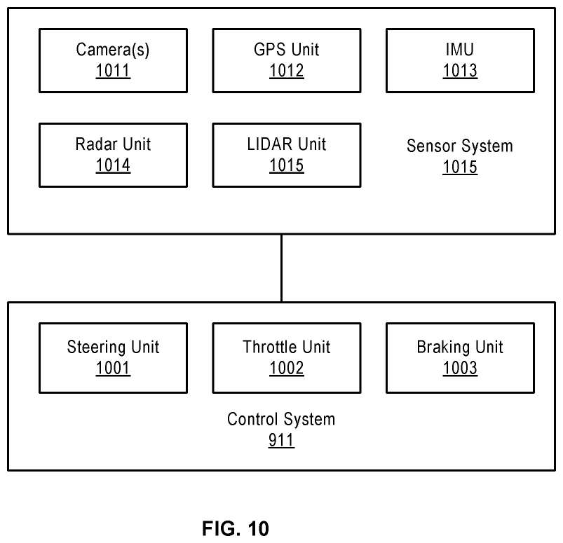

Referring now to FIG. 10, in one embodiment, sensor system 915 includes, but it is not limited to, one or more cameras 1011, global positioning system (GPS) unit 1012, inertial measurement unit (IMU) 1013, radar unit 1014, and a light detection and range (LIDAR) unit 1015. GPS system 1012 may include a transceiver operable to provide information regarding the position of the autonomous driving vehicle. IMU unit 1013 may sense position and orientation changes of the autonomous driving vehicle based on inertial acceleration. Radar unit 1014 may represent a system that utilizes radio signals to sense objects within the local environment of the autonomous driving vehicle. In some embodiments, in addition to sensing objects, radar unit 1014 may additionally sense the speed and/or heading of the objects. LIDAR unit 1015 may sense objects in the environment in which the autonomous driving vehicle is located using lasers. LIDAR unit 1015 could include one or more laser sources, a laser scanner, and one or more detectors, among other system components. Cameras 1011 may include one or more devices to capture images of the environment surrounding the autonomous driving vehicle. Cameras 1011 may be still cameras and/or video cameras. A camera may be mechanically movable, for example, by mounting the camera on a rotating and/or tilting a platform.

Sensor system 915 may further include other sensors, such as, a sonar sensor, an infrared sensor, a steering sensor, a throttle sensor, a braking sensor, and an audio sensor (e.g., microphone). An audio sensor may be configured to capture sound from the environment surrounding the autonomous driving vehicle. A steering sensor may be configured to sense the steering angle of a steering wheel, wheels of the vehicle, or a combination thereof. A throttle sensor and a braking sensor sense the throttle position and braking position of the vehicle, respectively. In some situations, a throttle sensor and a braking sensor may be integrated as an integrated throttle/braking sensor.

In one embodiment, vehicle control system 911 includes, but is not limited to, steering unit 1001, throttle unit 1002 (also referred to as an acceleration unit), and braking unit 1003. Steering unit 1001 is to adjust the direction or heading of the vehicle. Throttle unit 1002 is to control the speed of the motor or engine that in turn controls the speed and acceleration of the vehicle. Braking unit 1003 is to decelerate the vehicle by providing friction to slow the wheels or tires of the vehicle. Note that the components as shown in FIG. 10 may be implemented in hardware, software, or a combination thereof.

Referring back to FIG. 9, wireless communication system 912 is to allow communication between autonomous driving vehicle 901 and external systems, such as devices, sensors, other vehicles, etc. For example, wireless communication system 912 can wirelessly communicate with one or more devices directly or via a communication network. Wireless communication system 912 can use any cellular communication network or a wireless local area network (WLAN), e.g., using WiFi to communicate with another component or system. Wireless communication system 912 could communicate directly with a device (e.g., a mobile device of a passenger, a display device, a speaker within vehicle 901), for example, using an infrared link, Bluetooth, etc. User interface system 913 may be part of peripheral devices implemented within vehicle 901 including, for example, a keyboard, a touch screen display device, a microphone, and a speaker, etc.

Some or all of the functions of autonomous driving vehicle 901 may be controlled or managed by ADS 910, especially when operating in an autonomous driving mode. ADS 910 includes the necessary hardware (e.g., processor(s), memory, storage) and software (e.g., operating system, planning and routing programs) to receive information from sensor system 915, control system 911, wireless communication system 912, and/or user interface system 913, process the received information, plan a route or path from a starting point to a destination point, and then drive vehicle 901 based on the planning and control information. Alternatively, ADS 910 may be integrated with vehicle control system 911.

For example, a user as a passenger may specify a starting location and a destination of a trip, for example, via a user interface. ADS 910 obtains the trip related data. For example, ADS 910 may obtain location and route data from an MPOI server. The location server provides location services and the MPOI server provides map services and the POIs of certain locations. Alternatively, such location and MPOI information may be cached locally in a persistent storage device of ADS 910.

While autonomous driving vehicle 901 is moving along the route, ADS 910 may also obtain real-time traffic information from a traffic information system or server (TIS). Note that the servers may be operated by a third party entity. Alternatively, the functionalities of the servers may be integrated with ADS 910. Based on the real-time traffic information, MPOI information, and location information, as well as real-time local environment data detected or sensed by sensor system 915 (e.g., obstacles, objects, nearby vehicles), ADS 910 can plan an optimal route and drive vehicle 901, for example, via control system 911, according to the planned route to reach the specified destination safely and efficiently.

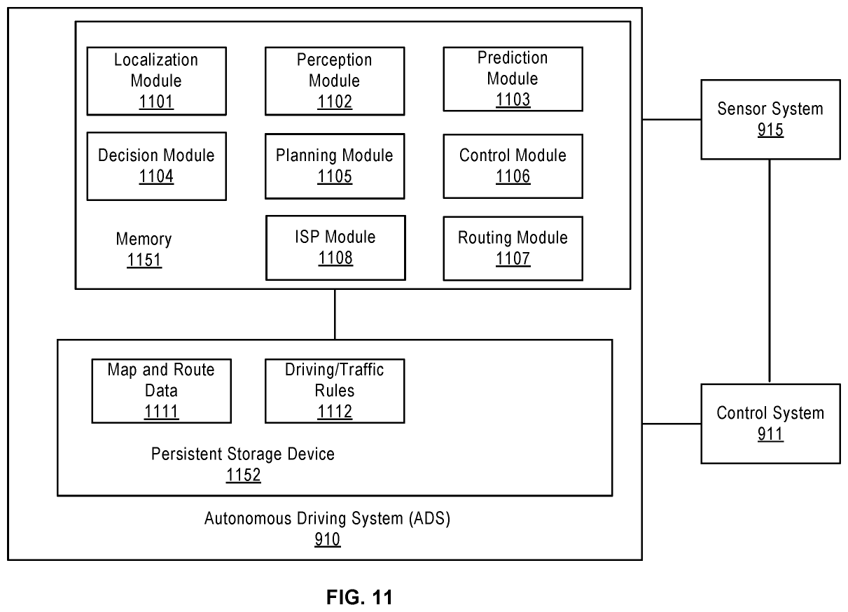

FIG. 11 is a block diagram illustrating an example of the autonomous driving system 910 according to an embodiment of the invention. The autonomous driving system 910 may be implemented as a part of autonomous driving vehicle 901 of FIG. 9 including, but is not limited to, ADS 910, control system 911, and sensor system 915.

Referring to FIG. 11, ADS 910 includes, but is not limited to, localization module 1101, perception module 1102, prediction module 1103, decision module 1104, planning module 1105, control module 1106, routing module 1107, ISP module 1108. These modules and the modules described in FIG. 6 perform similar functions.

Some or all of modules 1101-1108 may be implemented in software, hardware, or a combination thereof. For example, these modules may be installed in persistent storage device 1152, loaded into memory 1151, and executed by one or more processors (not shown). Note that some or all of these modules may be communicatively coupled to or integrated with some or all modules of vehicle control system 911 of FIG. 7. Some of modules 1101-1108 may be integrated together as an integrated module.

Localization module 1101 determines a current location of autonomous driving vehicle 901 (e.g., leveraging GPS unit 1012) and manages any data related to a trip or route of a user. Localization module 1101 (also referred to as a map and route module) manages any data related to a trip or route of a user. A user may log in and specify a starting location and a destination of a trip, for example, via a user interface. Localization module 1101 communicates with other components of autonomous driving vehicle 901, such as map and route data 1111, to obtain the trip related data. For example, localization module 1101 may obtain location and route data from a location server and a map and POI (MPOI) server. A location server provides location services and an MPOI server provides map services and the POIs of certain locations, which may be cached as part of map and route data 1111. While autonomous driving vehicle 901 is moving along the route, localization module 1101 may also obtain real-time traffic information from a traffic information system or server.

Based on the sensor data provided by sensor system 915 and localization information obtained by localization module 1101, a perception of the surrounding environment is determined by perception module 1102. The perception information may represent what an ordinary driver would perceive surrounding a vehicle in which the driver is driving. The perception can include the lane configuration, traffic light signals, a relative position of another vehicle, a pedestrian, a building, crosswalk, or other traffic related signs (e.g., stop signs, yield signs), etc., for example, in a form of an object. The lane configuration includes information describing a lane or lanes, such as, for example, a shape of the lane (e.g., straight or curvature), a width of the lane, how many lanes in a road, one-way or two-way lane, merging or splitting lanes, exiting lane, etc.

Perception module 1102 may include a computer vision system or functionalities of a computer vision system to process and analyze images captured by one or more cameras in order to identify objects and/or features in the environment of autonomous driving vehicle. The objects can include traffic signals, road way boundaries, other vehicles, pedestrians, and/or obstacles, etc. The computer vision system may use an object recognition algorithm, video tracking, and other computer vision techniques. In some embodiments, the computer vision system can map an environment, track objects, and estimate the speed of objects, etc. Perception module 1102 can also detect objects based on other sensors data provided by other sensors such as a radar and/or LIDAR.

For each of the objects, prediction module 1103 predicts what the object will behave under the circumstances. The prediction is performed based on the perception data perceiving the driving environment at the point in time in view of a set of map/rout information 1111 and traffic rules 1112. For example, if the object is a vehicle at an opposing direction and the current driving environment includes an intersection, prediction module 1103 will predict whether the vehicle will likely move straight forward or make a turn. If the perception data indicates that the intersection has no traffic light, prediction module 1103 may predict that the vehicle may have to fully stop prior to enter the intersection. If the perception data indicates that the vehicle is currently at a left-turn only lane or a right-turn only lane, prediction module 1103 may predict that the vehicle will more likely make a left turn or right turn respectively.

For each of the objects, decision module 1104 makes a decision regarding how to handle the object. For example, for a particular object (e.g., another vehicle in a crossing route) as well as its metadata describing the object (e.g., a speed, direction, turning angle), decision module 1104 decides how to encounter the object (e.g., overtake, yield, stop, pass). Decision module 1104 may make such decisions according to a set of rules such as traffic rules or driving rules 1112, which may be stored in persistent storage device 1152.

Routing module 1107 is configured to provide one or more routes or paths from a starting point to a destination point. For a given trip from a start location to a destination location, for example, received from a user, routing module 1107 obtains route and map information 1111 and determines all possible routes or paths from the starting location to reach the destination location. Routing module 1107 may generate a reference line in a form of a topographic map for each of the routes it determines from the starting location to reach the destination location. A reference line refers to an ideal route or path without any interference from others such as other vehicles, obstacles, or traffic condition. That is, if there is no other vehicle, pedestrians, or obstacles on the road, an ADV should exactly or closely follows the reference line. The topographic maps are then provided to decision module 1104 and/or planning module 1105. Decision module 1104 and/or planning module 1105 examine all of the possible routes to select and modify one of the most optimal routes in view of other data provided by other modules such as traffic conditions from localization module 1101, driving environment perceived by perception module 1102, and traffic condition predicted by prediction module 1103. The actual path or route for controlling the ADV may be close to or different from the reference line provided by routing module 1107 dependent upon the specific driving environment at the point in time.

Based on a decision for each of the objects perceived, planning module 1105 plans a path or route for the autonomous driving vehicle, as well as parameter values (e.g., distance, speed, and/or turning angle), using a reference line provided by routing module 1107 as a basis. That is, for a given object, decision module 1104 decides what to do with the object, while planning module 1105 determines how to do it. For example, for a given object, decision module 1104 may decide to pass the object, while planning module 1105 may determine whether to pass on the left side or right side of the object. Planning and control data is generated by planning module 1105 including information describing how vehicle 1101 would move in a next moving cycle (e.g., next route/path segment). For example, the planning and control data may instruct vehicle 901 to move 10 meters at a speed of 30 miles per hour (mph), then change to a right lane at the speed of 25 mph.

ISP module 1108 can process raw images captured various sensors (e.g., cameras) mounted on the ADV, and feed the processed images to the perception module 1102.

Based on the planning and control data, control module 1106 controls and drives the autonomous driving vehicle, by sending proper commands or signals to vehicle control system 911, according to a route or path defined by the planning and control data. The planning and control data include sufficient information to drive the vehicle from a first point to a second point of a route or path using appropriate vehicle settings or parameter values (e.g., throttle, braking, steering commands) at different points in time along the path or route.

In one embodiment, the planning phase is performed in a number of planning cycles, also referred to as driving cycles, such as, for example, in every time interval of 100 milliseconds (ms). For each of the planning cycles or driving cycles, one or more control commands will be issued based on the planning and control data. That is, for every 100 ms, planning module 1105 plans a next route segment or path segment, for example, including a target position and the time required for the ADV to reach the target position. Alternatively, planning module 1105 may further specify the specific speed, direction, and/or steering angle, etc. In one embodiment, planning module 1105 plans a route segment or path segment for the next predetermined period of time such as 5 seconds. For each planning cycle, planning module 1105 plans a target position for the current cycle (e.g., next 5 seconds) based on a target position planned in a previous cycle. Control module 1106 then generates one or more control commands (e.g., throttle, brake, steering control commands) based on the planning and control data of the current cycle.

Note that decision module 1104 and planning module 1105 may be integrated as an integrated module. Decision module 1104/planning module 1105 may include a navigation system or functionalities of a navigation system to determine a driving path for the autonomous driving vehicle. For example, the navigation system may determine a series of speeds and directional headings to affect movement of the autonomous driving vehicle along a path that substantially avoids perceived obstacles while generally advancing the autonomous driving vehicle along a roadway-based path leading to an ultimate destination. The destination may be set according to user inputs via user interface system 913. The navigation system may update the driving path dynamically while the autonomous driving vehicle is in operation. The navigation system can incorporate data from a GPS system and one or more maps so as to determine the driving path for the autonomous driving vehicle.

According to one embodiment, a system architecture of an autonomous driving system as described above includes, but it is not limited to, an application layer, a planning and control (PNC) layer, a perception layer, a device driver layer, a firmware layer, and a hardware layer. The application layer may include user interface or configuration application that interacts with users or passengers of an autonomous driving vehicle, such as, for example, functionalities associated with user interface system 913. The PNC layer may include functionalities of at least planning module 1105 and control module 1106. The perception layer may include functionalities of at least perception module 1102. In one embodiment, there is an additional layer including the functionalities of prediction module 1103 and/or decision module 1104. Alternatively, such functionalities may be included in the PNC layer and/or the perception layer. The firmware layer may represent at least the functionality of sensor system 915, which may be implemented in a form of a field programmable gate array (FPGA). The hardware layer may represent the hardware of the autonomous driving vehicle such as control system 911. The application layer, PNC layer, and perception layer can communicate with the firmware layer and hardware layer via the device driver layer.

Note that some or all of the components as shown and described above may be implemented in software, hardware, or a combination thereof. For example, such components can be implemented as software installed and stored in a persistent storage device, which can be loaded and executed in a memory by a processor (not shown) to carry out the processes or operations described throughout this application. Alternatively, such components can be implemented as executable code programmed or embedded into dedicated hardware such as an integrated circuit (e.g., an application specific IC or ASIC), a digital signal processor (DSP), or a field programmable gate array (FPGA), which can be accessed via a corresponding driver and/or operating system from an application. Furthermore, such components can be implemented as specific hardware logic in a processor or processor core as part of an instruction set accessible by a software component via one or more specific instructions.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the operation and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the disclosure also relate to an apparatus for performing the operations herein. Such a computer program is stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments of the present disclosure are not described with reference to any particular programming language. It will be appreciated that a variety of programming languages may be used to implement the teachings of embodiments of the disclosure as described herein.

In the foregoing specification, embodiments of the disclosure have been described with reference to specific embodiments thereof. It will be evident that various modifications may be made thereto without departing from the broader spirit and scope of the disclosure as set forth in the following claims. The specification and drawings are, accordingly, to be regarded in an illustrative sense rather than a restrictive sense.

What is claimed is:

1. A computer-implemented method of tuning an image signal processing (ISP) module of an autonomous driving vehicle (ADV), comprising:
For each of a predetermine number of iterations,
obtaining a raw image captured from by a sensor mounted on the ADV,
applying a set of ISP parameter values to the ISP module, and using the ISP module to process the raw image, resulting in a processed image,
generating an objective score by an ISP module testing device based on the processed image, and
storing the set of ISP parameter values and the corresponding objective score to a database;
selecting a set of optimal ISP parameter values from the database based on one or more criteria; and
configuring the ISP module using the set of optimal ISP parameter values.

2. The computer-implemented method of claim 1, wherein the determining the set of optimal ISP parameter values includes selecting one of a plurality of ISP parameter values that corresponds to a highest objective score.

3. The computer-implemented method of claim 1, wherein the set of ISP parameter values includes a white balance gain, a static color saturation, and a noise reduction strength.

4. The computer-implemented method of claim 1, wherein the ISP module testing device includes a reference image, and compares the reference image with the processed image in terms of each of the set of ISP parameter values to generate the objective score.

5. The computer-implemented method of claim 1, wherein the tuning service uses one of a random search algorithm, a grid search algorithm, and a Bayesian algorithm in generating each set of ISP parameter values.

6. The computer-implemented method of claim 1, wherein one of one or more user-defined criteria include the objective score being the highest.

7. The computer-implemented method of claim 1, wherein the predetermine number of iterations is specified in a configuration file either via a fixed a number or via a target objective score.

8. A non-statutory computer readable medium storing instructions for tuning an image signal processing (ISP) module of an autonomous driving vehicle (ADV), wherein the instructions, when executed by one or more processors of an autotuning framework, cause the autotuning framework to perform the operations comprising:
For each of a predetermine number of iterations,
obtaining a raw image captured from by a sensor mounted on the ADV,
applying a set of ISP parameter values to the ISP module, and using the ISP module to process the raw image, resulting in a processed image,
generating an objective score by an ISP module testing device based on the processed image, and
storing the set of ISP parameter values and the corresponding objective score to a database;
selecting a set of optimal ISP parameter values from the database based on one or more criteria; and
configuring the ISP module using the set of optimal ISP parameter values.

9. The non-statutory computer readable medium of claim 8, wherein the determining the set of optimal ISP parameter values includes selecting one of a plurality of ISP parameter values that corresponds to a highest objective score.

10. The non-statutory computer readable medium of claim 8, wherein the set of ISP parameter values includes a white balance gain, a static color saturation, and a noise reduction strength.

11. The non-statutory computer readable medium of claim 8, wherein the ISP module testing device includes a reference image, and compares the reference image with the processed image in terms of each of the set of ISP parameter values to generate the objective score.

12. The non-statutory computer readable medium of claim 8, wherein the tuning service uses one of a random search algorithm, a grid search algorithm, and a Bayesian algorithm in generating each set of ISP parameter values.

13. The non-statutory computer readable medium of claim 8, wherein one of one or more user-defined criteria include the objective score being the highest.

14. The non-statutory computer readable medium of claim 8, wherein the predetermine number of iterations is specified in a configuration file either via a fixed a number or via a target objective score.

15. A method of operating an autonomous driving vehicle (ADV), comprising:
receiving, by an image signal processing (ISP) on the ADV, a raw image captured by the ADV in a particular environment;
determining, by the ISP module, a color temperature value of the raw image;
obtaining a set of ISP parameter values corresponding to the color temperature value from a cloud database;
configuring the ISP module using the set of ISP parameter values; and
operating the ADV using processed images from the ISP module.

16. The method of claim 15, wherein the particular environment is one of a raining day, a sunny day, and in the darkness with beam lights on.

17. The method of claim 15, wherein the cloud database include a table for each of a plurality of modules in the ISP modules, wherein the table or each module in the ISP module include mapping entries between color temperature ranges and parameter values for that module.

18. The method of claim 17, the ISP module is configured to search the cloud database at a predetermined interval for a set of ISP parameter values.

19. The method of claim 15, wherein the set of ISP parameter values includes a white balance gain, a static color saturation, and a noise reduction strength.

20. The autotuning system of claim 15, wherein the set of ISP parameter values includes values for a set of parameters of one module in the ISP module, or values for all parameters in all the modules in the ISP modules.
